(19) United States
(12) Patent Application Publication
(10) Pub. No.: US 2010/0285172 A1
(43) Pub. Date: Nov. 11, 2010

(54) Metered Conveyor Feed System For Gum Components

(75) Inventor: James A. Duggan, Machesney Park, IL (US)

Correspondence Address: REINHART BOERNER VAN DEUREN P.C., 2215 PERRYGREEN WAY, ROCKFORD, IL, 61107, US

(73) Assignee: Cadbury Adams USA LLC, Parsippany, NJ (US)

(21) Appl. No.: 12/832,560

(22) Filed: Jul. 8, 2010

Related U.S. Application Data
(63) Continuation of application No. PCT/US2009/030439, filed on Jan. 8, 2009.
(60) Provisional application No. 61/019,644, filed on Jan. 8, 2008.

(51) Int. Cl. A23G 4/02; A23G 4/00; A23G 9/28

(52) U.S. Cl. 426/3; 137/602

(57) ABSTRACT

Methods and apparatuses are provided for conveying gum components and for making chewing gum compositions, by conveying a substantially horizontally stratified flow of two or more gum components along a conveying path. Once the horizontally stratified flow of gum components is established, the flow of gum components can be supplied to a gum mixing machine in a substantially constant cross-sectional ratio of the gum components, even where it is necessary to adjust the rate of flow of gum components along the conveying path, or to periodically start and stop the flow of components during the gum making process.

### CROSS-REFERENCE TO RELATED PATENT APPLICATIONS

This patent application is a continuation of co-pending PCT/US2009/030439 filed Jan. 8, 2009, designating the United States, which claims the benefit of U.S. Provisional Patent Application No. 61/019,644 filed Jan. 8, 2008, the entire teachings and disclosures of which are incorporated herein, in their entireties, by reference thereto.

### FIELD OF THE INVENTION

This invention is related to making chewing gum, and more particularly to a method and apparatus for making chewing gum.

### BACKGROUND OF THE INVENTION

The process of making chewing gum involves mixing together precisely controlled amounts of a number of gum components. Some of these components are liquids, which may need to be provided to the mixing device in a heated or a cooled state, while other components are provided to the mixing device as dry powders. Some of the components form a relatively large percentage of the total volume of gum components utilized for making the chewing gum, whereas other gum components make up only a small percentage of the overall volume of the gum components which are mixed together to form the chewing gum.

In recent years, making gum has become a more highly automated, and more continuous process than was the case in previous times. These advances have been possible in large part due to improvements in the machinery used for mixing the gum components together to form the final chewing gum product and in the control methodologies associated with gum mixing apparatuses and methods. Unfortunately, however, the methods and apparatuses used for conveying dry powder-type gum components to the mixing machine have not advanced significantly, and are retarding further improvements in the processes and machinery for making gum.

In the past, auger-type conveyors or mixers were typically used for conveying dry gum components. Auger-type conveyors are less than satisfactory for conveying dry components in modern gum making processes and machinery for several reasons. For example, auger conveyors typically have a very high clearance slippage, on the order of 30 percent or more, making it difficult to accurately control the volume of dry component being conveyed and fed to the gum mixing machine so that the component is interjected into the gum making process in a precisely controlled amount and at a particular time in the cycle which may be required for proper operation of the gum making machinery and achieving a desired mix of components in the completed chewing gum. This is particularly problematic when auger-type conveyors are utilized for conveying dry components which are used in small volumes. Such small volume components might include, for example, flavors or sweeteners.

Auger-type conveyors are particularly ineffective in highly automated, more-or-less, continuous processes, where the conveying speed may need to be periodically adjusted, or the conveying apparatus stopped and restarted in a close timing sequence with delivery of other gum components. When the auger-type device is stopped, the contents tend to settle or leak through clearance in such a manner that reliable feed cannot be instantaneously reestablished upon restarting the auger. Also, augers inherently mix together whatever components are being carried by the flites of the auger. For mixtures of dry powder-type gum components, which may include small volumes of one or more of the components, it is thus difficult to accurately and precisely control the feed of a small volume component in a desired ratio to another component, particularly if the other component is a larger volume component, during the conveying process.

It is desirable, therefore, to provide a new apparatus and method for conveying dry gum components, and a new method and apparatus for making gum in conjunction with such new conveying apparatuses and methods, which overcomes problems such as those laid out above, or present in prior gum making apparatuses and methods.

### BRIEF SUMMARY OF THE INVENTION

The invention provides improved methods and apparatuses for conveying gum components and for making gum, by conveying a substantially horizontally stratified flow of two or more dry gum components along a conveying path. Once the substantially horizontally stratified flow of gum components is established along the conveying path, the flow of gum components can be readily supplied to a gum mixing machine in a substantially constant cross-sectional ratio of the gum components, even where it is necessary to continually adjust the rate of flow of gum components along the conveying path, or to periodically start and stop the flow of components during the gum making process.

In one form of the invention, where the gum components include at least one high volume component and at least one low volume component, the invention may include depositing and retaining at least one of the at least one low volume components between a first and a second substantially horizontally stratified layer of the high volume components as the two or more dry gum components are transported along the conveying path to a delivery location along the conveying path. For example, where the conveying path is at least partially defined by a conveying surface that is moving along the conveying path and terminates at a delivery location along the conveying path, the low volume component may be deposited and retained between two layers of the high volume components, as the two or more components are transported along the conveying path to the delivery location, so that the low volume component will not be lost during transport of the gum components to the delivery location.

The invention may also be used to significant advantage for reducing the amount of clean-up required between runs of making chewing gum having different combinations of dry components. For example, where a conveying path is at least partially defined by a conveying surface that is moving along the conveying path and terminates at a delivery location along the conveying path, a method according to the invention may include forming a first substantially horizontally stratified flow of gum components by depositing a flow of a first gum component of two or more gum components onto the conveying surface upstream from the delivery location, and sequentially depositing a flow of one or more additional gum components on the first component in such a manner that the one or more additional gum components are substantially isolated from contact with the conveying surface by the first gum component. Once the production run of the chewing gum utilizing the first substantially horizontally stratified flow of gum components is completed, any remaining portion of the first substantially horizontally stratified flow of gum components is removed from the conveying surface, by any appropriate method, such as simply allowing the conveying surface to dump any unused portion of the flow of components into a waste receptacle. It is preferred, however, that the first flow of gum components on the conveyor be stopped in a sequential and timely manner, in accordance with other aspects of the invention as laid out herein, so that the conveying surface is left substantially free of components and so that there is essentially no waste of components created in the changeover.

Once the first flow of horizontally stratified gum components is removed from the conveying surface, a second combination of substantially horizontally stratified flow of gum components, which may have a different substantially constant cross-sectional ratio of gum components, may be created on the conveying surface, in accordance with the invention. To minimize the necessity for cleaning the conveying surface between production runs, the first gum component of the first substantially stratified flow of two or more gum components may be retained as the first component of the second flow of substantially horizontally stratified flow of two or more gum components, such that the first component substantially isolates the remaining components of the second flow of components from the conveying surface in the same manner as in the first substantially horizontally stratified flow of gum components. According to this aspect of the invention, because the same component is in contact with the conveying surface during both the first and second production runs, in some instances, it is not necessary to thoroughly clean the conveying surface between production runs. As a result, changeover time and cost can be reduced.

Once the horizontally stratified flow of two or more gum components is created, in accordance with the invention, practice of the invention may further include feeding the substantially horizontally stratified flow of two or more gum components to a gum making machine, and combining the horizontally stratified flow of two or more gum components with flows of one or more additional gum components in the gum making machine to form gum. Where the gum making machine is a substantially continuous flow extruder, the invention may further include controlling the substantially horizontally stratified flow of the two or more gum components and the flow of the one or more additional gum components to provide a substantially continuous flow of gum from the gum making machine.

The invention may include conveying the substantially horizontally stratified flow of the two or more gum components to a delivery location along at least a portion of the conveying path on a conveying surface moving along the conveying path, with each of the two or more components being deposited into the substantially stratified flow of the two or more components at respective feeder locations spaced from one another along the portion of the conveying path. The depositing of each of the two or more gum components may be controlled according to one or more control schemes, such as those set out in paragraphs a, b, c or d below:
a) A first control scheme may include sequentially initiating deposition of each of the two or more gum components, starting with initiation of a first component of the two or more gum components at a location along the portion of the conveying path farthest from the delivery location, to form a leading edge of the first component. Deposition of each additional gum component of the two or more gum components may then be subsequently initiated as the leading edge of the first gum component has substantially passed the respective feeder location for that additional gum component, to thereby establish the substantially stratified flow of two or more gum components from the leading edge of the first component has substantially reached to the delivery location along the conveying path.
b) A second control scheme, according to the invention, may include sequentially stopping deposition of each of the two or more gum components, starting with termination of deposition of a first gum component of the two or more gum components at a location along the portion of the conveying path farthest from the delivery location, to form a trailing edge of the first gum component. Deposition of each additional gum component may then be subsequently stopped as the trailing edge of the first gum component has substantially reached the respective feeder location for that additional gum component, to thereby maintain the substantially horizontally stratified flow of two or more gum components to the delivery location until the trailing edge of the first gum component has substantially reached the delivery location along the conveying path. Practice of this control scheme leaves the conveying surface behind the trailing edge substantially free of any of the two or more gum components.
c) A control scheme, according to the invention, may include simultaneously stopping movement of the conveying surface along the conveying path and deposition of each of the two or more gum components. Such a control scheme might be used, for example, when it is necessary to interrupt a continual flow of the gum components to the gum making machine, and yet have the substantially horizontally stratified flow of gum components be available for substantially instantaneous restarting of the flow when needed in the gum making process.
d) Another control scheme, according to the invention, may include simultaneously starting movement of the conveying surface along the conveying path and deposition of each of the two or more gum components. Such a scheme might be utilized, for example, upon re-starting the conveyor after executing control scheme c) above.

In some forms of the invention, wherein the conveying path is at least partially defined by a conveying surface that is moving along the conveying path and terminates at a delivery location (D) along the conveying path, the invention may include depositing a flow of a first gum component (component A) of the two or more gum components onto the conveying surface upstream from the delivery location D, and sequentially depositing a flow of a second component (component B) of the two or more gum components on top of component A, in such a manner that the flow of component B rests on the flow of component A and is substantially isolated from contact with the conveying surface by component A. In some forms of the invention, where the flow of gum components further includes a third gum component (component C), the invention may further include depositing the flow of component C subsequent to depositing the component B in such a manner that the component C is substantially isolated from contact with the conveying surface by at least component A. In other forms of the invention, wherein the flow of gum components further includes a third component (component C) the invention may include depositing the flow of component C onto the flow of component B in such a manner that component C is substantially isolated from contact with the conveying surface by both component B and component A. Where component A and component C constitute a first and a second high volume component, and component B constitutes a low volume component, the invention may include depositing and retaining a low volume component B between the first and second high volume components A and C as the components A, B and C are transported along the conveying path to the delivery location.

In some forms of the invention, the substantially horizontally stratified flow of gum components may contain flows of first and second components A, B and one or more tertiary components (component C₁ . . . Cₙ) sequentially deposited on top of one another to form a substantially stratified flow of materials with substantially only component A being in contact with the conveying surface. The invention may further include changing the components in the flow of gum components to form an alternate combination of the flow of gum components, but retaining component A in contact with the conveying surface and substantially isolating the remaining components of the flow of components from the conveying surface. The flows of components may be sequentially deposited in such a manner that the stratified components are deposited in a substantially constant longitudinal order, along the conveying path form a location of initial deposit of component A to the delivery location D. Some forms of the invention may include controlling the manner in which the stratified components are deposited in the substantially constant longitudinal order along the conveying path from the location of initial deposit of component A to the delivery location D, during at least one of initiation or termination of movement of the conveying surface along the conveying path.

The invention may also take the form of an apparatus for conveying a substantially stratified flow of two or more gum components in a desired ratio of the components to a delivery location along a conveying path, where the components contain at least a first gum component (component A) and a second gum component (component B). Such an apparatus, according to the invention, may include a conveying arrangement and a component feeder arrangement. The conveying arrangement may have a conveying surface that is moveable along the conveying path from a location of depositing component A to the delivery location. The component feeder arrangement may be configured for depositing a flow of the first gum component (component A) of the two or more gum components onto the conveying surface at the location A of depositing component A, and subsequently depositing a flow of component B on top of component A in such a manner that the flow of component B rests on the flow of component A and is substantially isolated form contact with the conveying surface by component A.

An apparatus, according to the invention, may include a gum making machine having a dry-component inlet operatively configured and connected to the delivery location of the conveying arrangement for receiving the flow of components from the conveying arrangement. The gum making machine may further include an other-gum-component-inlet for receiving other gum components to be mixed by the gum making machine with the flow of components from the conveying arrangement.

Where a flow of gum components includes one or more tertiary components (component C₁ . . . Cₙ) a component feeder apparatus, according to the invention, may include a first component feeder, a second component feeder, and one or more tertiary component feeders. The first component feeder (feeder A) may be disposed along the conveying path for depositing the flow of component A at location A. The second component feeder (feeder B) may be disposed along the conveying path for depositing the flow of component B at a location B spaced along the conveying path between the location A and the delivery location D. The one or more tertiary component feeders (feeder C₁ . . . Cₙ) may be disposed along the conveying path at respective tertiary locations (tertiary location C₁ . . . Cₙ) between location B and the delivery location D for depositing a flow of each one of the one or more tertiary components C₁ . . . Cₙ at its respective tertiary location C₁ . . . Cₙ.

An apparatus, according to the invention, may also include a controller operatively connected to the conveying arrangement and the feeding arrangement for controlling the conveying and feeding arrangements to sequentially deposit the first, second and tertiary components A, B, C₁ . . . Cₙ on top of each other to form a substantially horizontally stratified flow of components with substantially only component A being in contact with the conveying surface. Where the flow of component A defines a leading edge thereof during establishment of the flow of components from the feeder location A toward the delivery location D, the controller may sequentially initiate deposition of the second and tertiary components B and C₁ . . . Cₙ after the leading edge of component A has substantially passed each respective feeder location B and C₁ . . . Cₙ.

Where the flow of component A defines a trailing edge thereof during termination of the flow of components from the feeder location A toward the delivery location D, the controller may first terminate the deposition of component A and then sequentially terminate deposition of each of second and tertiary components B, C₁ . . . Cₙ after the trailing edge of component A has substantially reached each respective feeder location B and C₁ . . . Cₙ. In some forms of the invention, the controller my terminate the deposition of all of the components A, B, C₁ . . . Cₙ, simultaneously with stopping motion of the conveying surface toward the delivery location. The controller may also initiate the deposition of all of the components A, B, C₁ . . . Cₙ, simultaneously with starting motion of the conveying surface toward the delivery location, after previously simultaneously stopping the deposition of all of the components and conveyor motion where the conveyor has been operating with a fully established stratified flow of gum component.

Other aspects, objects and advantages of the invention will be apparent from the following detailed description and accompanying drawings of exemplary embodiments of the invention.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic illustration of a first exemplary embodiment of a gum making apparatus, according to the invention, which includes a metering conveyor apparatus for forming and conveying a horizontally stratified flow of gum components to a gum making machine;

FIGS. 2-6 are schematic cross-sectional illustrations of various forms of horizontally stratified flows of gum components, according to the invention;

FIGS. 7-14 are schematic illustrations of an exemplary control scheme for initiating a stratified flow of gum components in a metering conveyor, according to the invention;

FIGS. 15-22 are sequential schematic illustrations of an exemplary control scheme for terminating a stratified flow of gum components in a metering conveyor, according to the invention;

FIGS. 23-25 are sequential schematic illustrations showing an exemplary control scheme for instantaneously stopping, pausing and restarting a stratified flow of gum components in a metering conveyor, according to the invention; and

FIG. 26 is a schematic illustration of a second embodiment of a gum making apparatus, according to the invention, which includes a metering conveyor apparatus for forming and conveying a horizontally stratified flow of gum components to a gum making machine that incorporates an ingredient feeder for dispensing a liquid ingredient.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

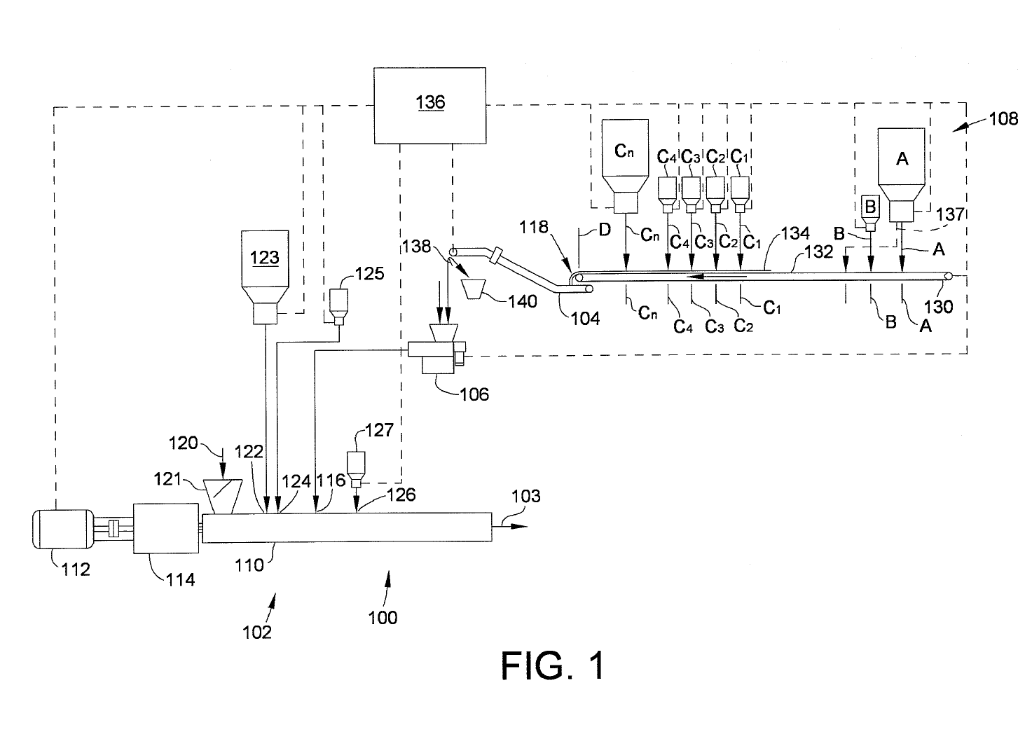

FIG. 1 illustrates a first exemplary embodiment of a gum making apparatus 100 according to the invention. The first exemplary embodiment 100 includes a gum making machine 102 operatively connected by a transfer conveyor 104 and a component injection mechanism 106, and typically a dry component injection mechanism, to a metering conveyor apparatus 108, according to the invention.

As shown in FIG. 1, the exemplary embodiment of a gum making machine 102 is an extruder-type machine having a mixing section 110 driven by an electric motor 112 through a drive mechanism 114 for making a substantially continuous output of gum 103. The gum making machine 102 further includes a gum-component-inlet 116 which is operatively configured and connected for delivering a flow of gum components to the mixing section 110 of the gum making machine 102. The gum making machine 102 also includes additional other-gum-component inlets 120, 122, 124 located upstream from gum-component inlet 116, and a further other-gum-component inlet 126 located downstream from gum-component inlet 116 along the mixing section 110 of the gum making machine 102.

It will be understood, by those skilled in the art, that the type of gum making machine 102 and the placement and number of other-gum-component-inlets 120, 122, 124, 126 have been selected for purposes of illustration in the exemplary embodiment 100, and are not necessarily representative or limiting of the type of gum making machine or the number or placement of any such inlets with respect to the gum-component inlet 116 in actual practice of the invention. It will also be understood that, although the exemplary embodiment of the gum making apparatus 100 utilizes a continuous mixer, in the form of the extruder-type gum making machine 102, other embodiments of the invention may use batch mixers rather than continuous mixers and may use one or more mixers.

For purposes of illustration, various types of feeding mechanisms 121, 123, 125, 127 have been shown operatively connected to the first through fourth other-gum-component-inlets 120, 122, 124, 126, in FIG. 1. It will be understood that the shape and size of these feeders 121, 123, 125, 127 are purely schematic and not necessarily indicative or limiting of a particular type of feeder being utilized at any one of the first through fourth other-gum-component-inlets 120, 122, 124, 126.

As shown in FIG. 1, the metering conveyor in the exemplary embodiment of the gum making apparatus 100 includes a through-type conveyor 130 having a conveyor belt, or other moveable upper surface 132 thereof which defines a portion of a path 134 for conveying dry gum components to the delivery location D, which is located along the path 134.

As further shown in FIG. 1, the metering conveyor apparatus 108 in the first exemplary embodiment of the gum making apparatus 100 also includes a series of feeders linearly spaced along the path 134. Specifically, the exemplary embodiment of the metering conveyor 108 includes a first feeder A, a second feeder B, and five tertiary feeders C₁, C₂, C₃, C₄, Cₙ. As shown in FIG. 1, the feeders A, B and C₁ . . . Cₙ are linearly spaced from one another upstream of the delivery location D along the path 134 at locations bearing the same reference designation A, B and C₁ . . . Cₙ as their respective feeder A, B and C₁ . . . Cₙ, with the same designations being used for purposes of clarity of explanation. Each of the feeders A-Cₙ is configured and controlled to provide a metered flow of a specific gum component A-Cₙ matching the designation of its respective feeder A-Cₙ.

In typical implementations, these gum components A-Cₙ will be dry gum components. However, other embodiments may incorporate feeders for dispensing non-dry components onto conveyor 130, as will be more fully described below.

As used herein, a “gum component” can be any type of ingredient added to a gum composition, and includes, but is not limited to gum base ingredients and finished gum ingredients.

As will be described in more detail below, the metering conveyor apparatus 108 is utilized, according to embodiments of the invention, for generating and conveying a substantially stratified flow 118 of two or more of the dry gum components (A, B, C₁ . . . Cₙ) to the delivery location D along the conveying path 134 defined by an upper surface 132 of the conveyor 130.

As shown in FIG. 1, the first exemplary embodiment of a gum making apparatus 100 also includes a controller 136, which is operatively connected as indicated by dashed lines in FIG. 1, to all of the other components of the first exemplary embodiment 100, and particularly to the metering conveyor 108 and the feeding arrangements A-Cₙ, to thereby allow for sequentially depositing of one or more of the first, second and tertiary components A, B, C₁ . . . Cₙ on top of one another to form the substantially stratified flow 118, in a desired stratification arrangement on the conveying surface 132. By controlling the speed at which the conveying surface 132 moves toward the delivery location D and the metering the rate at which the components A-Cₙ are deposited onto the conveying surface 132, a substantially constant cross-sectional ratio of the dry components A-Cₙ can be formed and conveyed to the delivery location D. By controlling the metering conveyor apparatus 108 in coordination with the other components of the exemplary embodiment, a continual flow of a desired gum formulation 103 may be produced by the gum making machine 102. Thus, variations in formulations, may change which components get dispensed and how much each dispensed component gets dispensed onto the conveying surface 132.

Additionally, the controller may adjust the speed of the convey surface 132 from one formulation to another formulation. Also, the speed of the conveyor surface 132 can be adjusted based on the capacity of material that can be handled by the mixer into which the components are being dispensed.

Although a single controller 136 is shown in FIG. 1 as being connected to all components of the first exemplary embodiment of the gum making apparatus 100, it will be understood that in other embodiments of the invention separate controllers may be utilized for controlling one or more components in a manner appropriate for a given application of the invention. It will be further understood that the controller 136, or controllers, in various embodiments of the invention, may utilize any appropriate method of open or closed-loop control known in the art.

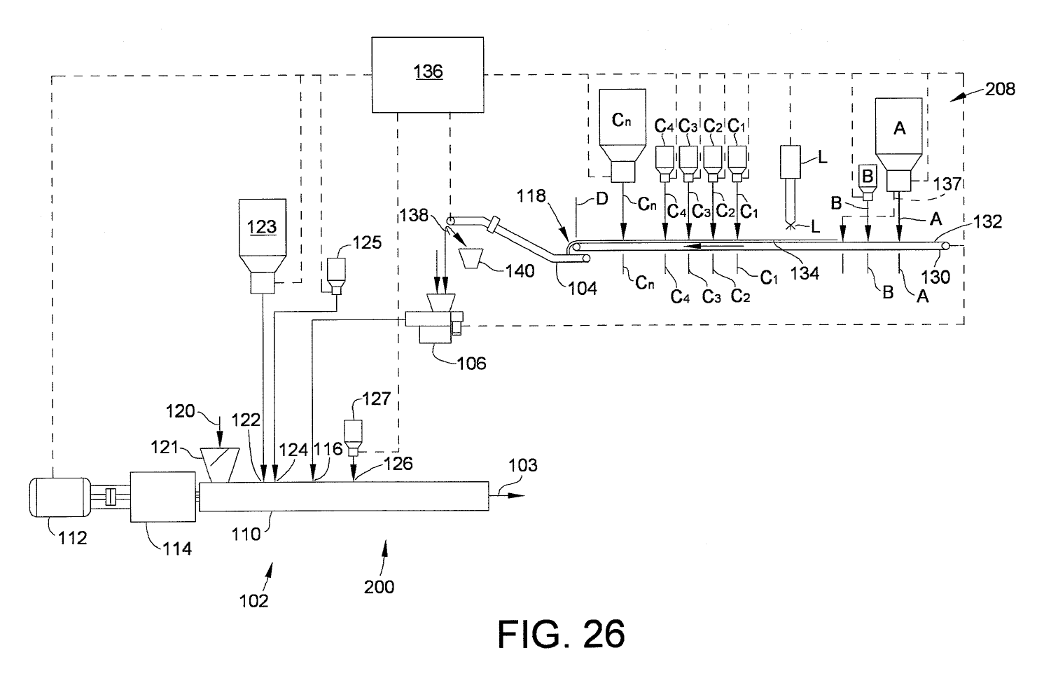

FIG. 26 illustrates another embodiment of a gum making apparatus 200 according to the teachings of the present invention. The gum making apparatus 200 is similar in many respects to the embodiments described previously. The gum making apparatus 200 primarily differs in the configuration of the conveyor apparatus 208. In this embodiment, the conveyor apparatus 208 further includes a non-dry component dispenser L that dispenses non-dry gum component L, bearing the same reference designation as the liquid dispenser L. While a single non-dry component dispenser L is illustrated, it is contemplated that multiple non-dry gum dispensers may be incorporated into alternative embodiments and at different locations along path 134 for different formulations.

When dispensing non-dry gum components L into the component flow 118 onto conveyor apparatus 208, it is preferred, but not required, to use the non-dry component dispenser L to dispense low quantity ingredients such that the non-dry gum component does not cause the component flow 118 from becoming too damp such that it becomes tacky or sticky. This prevents the flow 118 from sticking to the conveyor 130 or to the ingredient injector 106. Alternatively, the non-dry component may be an ingredient that is dispensed as a liquid but that dries quickly reducing the potential of the non-dry component from contacting the conveyor 130.

As such, in typical implementations it is contemplated that the non-dry component dispenser L will be used for components such as, by way of example only, liquid flavors or liquid colorants that encompass a very small percentage of the finished gum product. In such a configuration, by using the conveyor apparatus 208 to dispense the low quantity ingredients such as flavor or color, these ingredients get the benefits of being accurately metered and evenly dispersed in the finished gum product. Alternatively, the non-dry component may be an ingredient that is dispensed as a liquid but that dries quickly reducing the potential of the non-dry component from contacting the conveyor 130.

It is contemplated, preferably, to dispense the non-dry gum component L onto one or more of the other components A, B, C₁ . . . Cₙ that are dry to prevent the non-dry gum component L from contaminating or adhering to the conveyor 130. It is contemplated to be even more preferable to dispense the non-dry gum component onto a large quantity of dry gum components such that any absorption of the non-dry component L into the dry component does not allow the non-dry component L to sufficiently absorb such that it contacts or reaches conveyor 130.

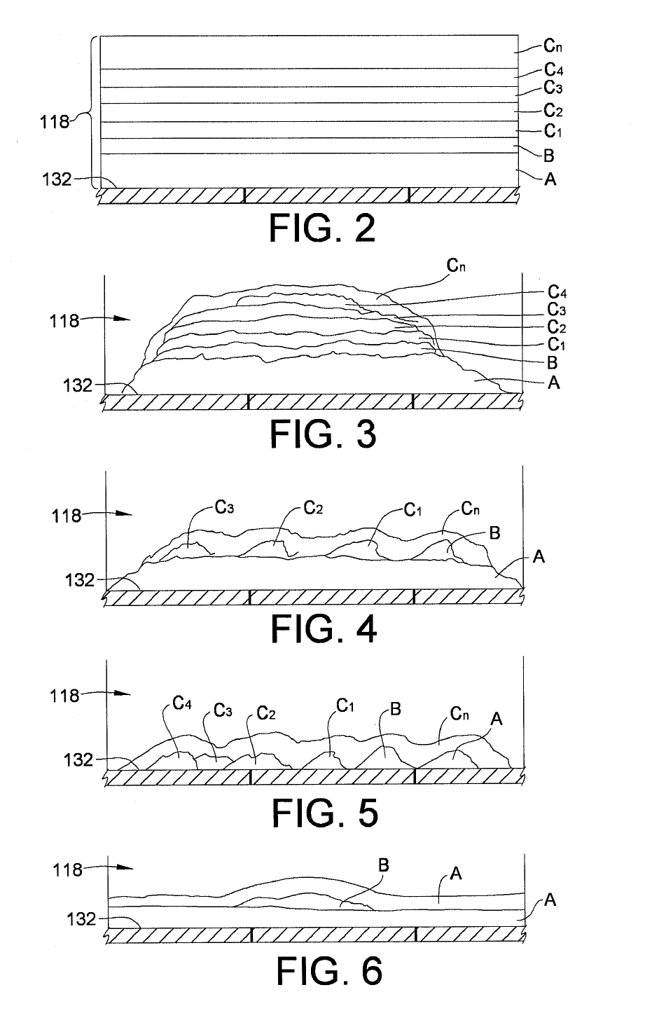

As illustrated in FIGS. 2-6, the term “stratified flow 118,” according to the invention, may take a variety of forms in various embodiments of the invention. For example, FIG. 2 illustrates schematically a fully-formed stratified flow 118 having seven layers A-Cₙ supported on a conveying surface 132. As shown in FIGS. 3-5, however, in actual practice the various layers A-Cₙ may not extend completely across the entire width of the conveying surface 132. For example, in FIG. 3, the components B-Cₙ are sequentially deposited one on top of another, with all of the layers after the first layer of component A being supported on top of component A, such that only component A is actually in contact with the conveying surface 132, even though each of the layers of components A-Cₙ is conveyed along the metering conveyor 108 in a respective cross-sectional angle of repose.

FIG. 4 illustrates another possible embodiment for the stratified flow of dry components A-Cₙ in which component A rests on the conveying surface 132 with components B-C₃ having a lower volume than component A or Cₙ, and the lower volume components B-C₃ being encapsulated between the higher volume components A and Cₙ. In this manner, the high volume components A and Cₙ serve to effectively encapsulate the low volume components B, C₁, C₂, C₃, to effectively and efficiently preclude loss of the lower volume components B-C₃ as the stratified flow 118 of components moves along the metering conveyor apparatus 108 to the delivery location D.

In similar fashion, FIG. 5 illustrates an embodiment of the stratified flow 118 in which components A, B, C₁, C₂, C₃ are separately deposited onto the conveying surface 132 and covered with a layer of a high volume component C₄, to preclude loss of any appreciable volume of the low volume components A-C₃.

FIG. 6 illustrates another embodiment of a stratified flow 118 of dry gum components, according to the invention, in which a low volume component B is deposited between first and second layers of a higher volume component A. This can be accomplished, in some embodiments of the invention, in the manner illustrated by dashed line 137 extending from feeder A in FIG. 1, by providing an additional feed mechanism from feeder A to deposit a portion of the high volume component A upstream, and a second portion of the high volume component A downstream, from the point of deposit onto the metering conveyor of the lower volume component B. Alternatively, one of the tertiary feeders, such as feeder Cₙ may be utilized as a second source of the higher volume component A.

The term “stratified flow,” as used herein is contemplated to include some degree of inherent mixing of the components as they are deposited onto and conveyed by the conveyor 108, due to factors such as vibration or gravitational force acting on the components as they flow over each other while being sequentially deposited onto the conveyor 108. Such mixing will be substantially insignificant, however, in comparison to the degree of undesirable mixing that occurs in prior gum making apparatuses and methods, using an auger-type conveyor for example.

### EXAMPLES

Table 1 illustrates a general example of a finished gum composition that may be formed using the exemplary embodiment of the gum making apparatus 100 by feeding the components to the gum making machine 102 at the various inlets 116, 120, 122, 124, 126 from corresponding component feeders 106, 121, 123, 125, 127, in accordance with a desired ratio of the components shown in Table 1.

TABLE 1

| | Weight Percent of Finished |
|---|---|
| Component | Gum Composition |
| Finished Gum Base | |
| Gum Base | 10-30% |
| Additional Filler | |
| Calcium Carbonate | 5-30% |
| Bulk Sweeteners | |
| Hydrogenated Starch | 0-10% |
| Hydrolysates | |
| Sorbitol | 20-70% |
| Erythritol | 0-20% |
| Xylitol | 0-20% |
| Maltitol | 0-60% |
| Isomalt | 0-20% |
| Mannitol | 0-60% |
| High Intensity Sweeteners | |
| Neotame | 0-1% |
| Sucralose | 0-1% |
| Ace-K | 0-1% |
| Aspartame | 0-3% |
| Encapsulated Sweetener | |
| Sucralose | 0-7% |
| Encapsulated in PVA | |
| Aspartame | 0-7% |
| Encapsulated in PVA | |
| Fluids | |
| Glycerin | 0.1-15% |
| Emulsifiers | |
| Lecithin | 0.1-10% |
| Flavor | 0.1-3% |
| Acid(s) | 0.1-10% |
| Color(s) | .001-0.2% |

As used herein, “gum composition” includes, but is not limited to, compositions ranging from and inclusive of compounded elastomer to finished gum, which may include compounded elastomer in addition to some compounding aids, master batch gum base, compounded elastomer in addition to some subsequent gum ingredients, compounded elastomer in addition to some gum base ingredients and some subsequent gum ingredients, gum base, gum base in addition to some subsequent gum ingredients, master batch finished gum, and finished gum. The present invention is not limited to forming or use with any one of these gum compositions. Specifically, the final output from gum making apparatuses according to the present invention may be a finished gum, less than a finished gum, more or less than a finished gum base, etc.

As used herein, a “component” and “ingredient” may be used interchangeably.

A “finished gum”, as used herein, will refer to a gum composition that is generally ready for preparation to distribute the product to the consumer. As such, a finished gum may still require temperature conditioning, forming, shaping, packaging and coating. However, the gum composition itself is generally finished. Not all finished gums have the same components or the same amounts of individual components. By varying the components and amounts of components, textures, flavor and sensations, among other things, can be varied to provide differing characteristics to meet the needs of users.

As is generally well known, a finished gum generally includes a water soluble bulk portion, a water insoluble gum base portion, and one or more flavoring agents. The water soluble portion dissipates over a period of time during chewing. The gum base portion is retained in the mouth throughout the chewing process. A finished gum is typically ready for user consumption.

A “finished gum base,” as used herein, will refer to a gum composition that includes a sufficient combination of gum base components that need only be combined with subsequent gum components to form a finished gum. A finished gum base is a chewable visco-elastic material that includes at least a viscous component, an elastic component, and a softener component. For example, a typical gum base may include elastomer, at least some of the filler, resin and/or plasticizer, polyvinyl acetate, and a softener (such as an oil, fat or wax). Merely compounded elastomer without the addition of any softener, for example, would not be a finished gum base because it would not be considered useable in a finished gum composition because of its difficulty, if not impossibility, to chew.

Gum compositions may include a vast number of components in various categories. Systems and methods of the present invention may be used to mix or convey any and all known ingredients including, but not limited to, components in the following component (ingredient) categories: elastomers, bulking agents, elastomer plasticizers (which includes resins), elastomer solvents, plasticizers, fats, waxes, fillers, antioxidants, sweeteners (e.g. bulk sweeteners and high intensity sweeteners), syrups/fluids, flavors, sensates, potentiators, acids, emulsifiers, colors, and functional components.

Further discussion of representative components within each category can be found in U.S. patent application Ser. No. 12/338,682, filed on Dec. 18, 2008, and entitled “Parallel Gum Component Mixing Systems and Methods,” the teachings and disclosure of which are incorporated herein by reference thereto.

The insoluble gum base generally includes components falling under the following categories: elastomers, elastomer plasticizers (resins or solvents), plasticizers, fats, oils, waxes, softeners and fillers. The gum base may constitute between 5-95% by weight of a finished gum, more typically 10-50% by weight of the finished gum, and most commonly 20-30% by weight of the finished gum.

The water soluble portion of finished gum may includes subsequent gum components falling under the following categories: softeners, bulk sweeteners, high intensity sweeteners, flavoring agents, acids, additional fillers, functional components and combinations thereof. Softeners are added to the gum in order to optimize the chewability and mouth feel of the gum. The softeners, which are also known as plasticizers, plasticizing agents or emulsifiers, generally constitute between about 0.5-15% by weight of the gum structure. Bulk sweeteners constitute between 5-95% by weight of the gum structure, more typically 20-80% by weight of the gum and most commonly 30-60% by weight of the gum. High intensity sweeteners may also be present and are commonly used with sugarless sweeteners. When used, high intensity sweeteners typically constitute between 0.001-5% by weight of the gum structure, preferably between 0.01-3% by weight of the chewing gum. Typically, high intensity sweeteners are at least 20 times sweeter than sucrose.

Flavor should generally be present in the gum in an amount within the range of about 0.1-15% by weight of the chewing gum, preferably between about 0.2-5% by weight of the gum, most preferably between about 0.5-3% by weight of the gum. Natural and artificial flavoring agents may be used and combined in any sensorially acceptable fashion. When included, acids typically constitute between about 0.001-5% by weight of the gum structure.

Optional ingredients such as colors, functional components and additional flavoring agents may also be included in gum compositions.

As used herein, it is contemplated that the term “dry” gum components would encompass components, such as those listed above in Table 1, or any other applicable gum component, supplied to the metering conveyor 108 in forms such as granules, pellets, flour, or powder.

The gum base of Table 1, which forms a component of the finished gum composition can take many forms and have numerous formulas as is well known in the art. A representative and non-limiting listing of components of a gum base that may be used with the finished gum illustrated in Table 1 follows.

TABLE 2

| | Weight Percent |
|---|---|
| Component | of Gum Base |
| Elastomers (High Molecular | |
| Weight) | |
| Butyl Rubber | 4-8% |
| Styrene-butadiene Rubber | |
| Additional Elastomers | |
| Polyvinyl Acetate (PVA) | 10-30% |
| Elastomers (Low Molecular | |
| Weight) | |
| Polyisobutylene | 8-10% |
| Softeners/Plasticizers/Oils/Waxes | |
| Rosin esters | 5-10% |
| Waxes | 8-12% |
| Vegetable oils (hydrogenated) | 15-25% |
| Emulsifiers | 5-10% |
| Triacetin | |
| Glycerol Monostearate | |
| Lecithin | |
| Fillers | |
| Calcium Carbonate | 0-10% |
| Talc | 0-10% |
| Totals: | 100 |

To more fully illustrate the use of the conveyor apparatus 108 during formulation and formation of a finished gum composition, using a gum making apparatus or method according to the invention, the manner in which particular contemplated examples may be made, in accordance with the invention, are described below with reference to Table 1 and FIGS. 1, 3 and 6,

### Example 1

In a first particular contemplated example, the gum mixing machine 102, in a gum making apparatus and method according to the invention, takes the form of a continuous mixer, more particularly a continuous extruder. Further, the conveyor apparatus 108 is used to deliver a stratified flow 118 of only dry gum components. While the dry gum components may include dry flavors, sweeteners (including bulk sweeteners, high-intensity sweeteners and/or encapsulated sweeteners), and fillers, the stratified flow 118 of this second example will primarily be in the form of dry sweeteners.

Filler is added to the gum mixing machine 102 at feed port 121 in the form of calcium carbonate at a rate of about 10% by weight. Next, gum base is added to the gum mixing machine 102 from feeder 123 into inlet 122 at a rate of approximately 20% by weight percent of the finished gum, in a substantially liquid form. Glycerin and lecithin are then added to the gum making machine 102 downstream from the gum base, such as at inlet 124 at rates of about 4.9% by weight of the finished gum and about 3% by weight of the finished gum, respectively.

Dry sweeteners are added to the gum making machine 102 at inlet 116 downstream of the filler (added at inlet 121) and gum base (added at inlet 122). The dry sweeteners are injected into the gum making machine 102 by component injector 106 at inlet 116. Prior to being injected into the gum making machine 102, the dry sweeteners are metered onto conveyor 130 of metering conveyor apparatus 108 forming a stratified flow 118 of dry sweetener components.

A first dry sweetener metered on the conveyor apparatus is contemplated to include sorbitol, a large quantity ingredient for this contemplated gum composition, at a weight percent of about 30% by weight of the finished gum from feeder A. As such, sorbitol forms the first layer of the stratified flow 118 formed by the components of metering conveyor apparatus 108 traveling along path 134. Downstream from the addition of sorbitol, lower quantity sweeteners in the form of a high intensity sweetener, more particularly aspartame, at the rate of about 2% by weight of the finished gum is added as the next ingredient component of the stratified flow 118. The aspartame may be fed, for example, from feeder B. As the aspartame is added downstream of the large quantity ingredient sorbitol, the aspartame resides on top of the sorbitol, such as is illustrated for example by ingredients A and B, respectively, in FIG. 3. Moving along path 134, encapsulated sweetener in the form of encapsulated aspartame is added to the stratified flow 118 from feeder C₁ at a rate of about 3% by weight of the finished gum. Again, the encapsulated sweetener resides on top of the sorbitol and aspartame, such that these low quantity ingredients are prevented from contaminating the conveyor 130. Finally, a second large quantity ingredient, an additional bulk sweetener in the form of mannitol, is added to the stratified flow 118 at a rate of about 25% by weight of the finished gum from feeder Cₙ. As illustrated in FIG. 3, the large quantity mannitol Cₙ covers the low quantity components aspartame B and encapsulated aspartame C₁, such that the low quantity components are encapsulated between the two large quantity components sorbitol A and mannitol Cₙ. The stratified flow 118 is then dispensed onto transfer conveyor 104 where it is added to component injector 106, which injects the stratified flow 118 into the gum making machine 102.

Downstream from inlet port 116, additional liquid components including flavors, acids and color are injected into gum making machine 102 in a liquid form at a rate of about 1% by weight of the finished gum, 1% by weight of the finished gum, 0.1% by weight of the finished gum, respectively, are added to gum making machine 102 at inlet 126.

### Example 2

A second particular example of making a representative gum composition having a composition that is similar to but different from the composition of the first particular example is explained below with reference to FIG. 1 and FIGS. 3 and 6.

In this second contemplated example, the large quantity bulk sweetener is used to both, separate the other ingredients from the conveyor 130 as well as to encapsulate the lower quantity ingredients, much like the schematic illustration of FIG. 6. However, as there will be more than two components, FIG. 3 will be the primary reference for the stratified flow 118.

The gum mixing machine 102, once again, takes the form of a continuous mixer, more particularly a continuous extruder. Further, the conveyor apparatus 108 is used to deliver a stratified flow 118 of only dry sweetener components.

Additional filler is added to the gum mixing machine 102 at feed port 121 in the form of calcium carbonate at a rate of about 10% by weight of the finished gum. Next, gum base is added to the gum mixing machine 102 from feeder 123 into inlet 122 at a rate of approximately 20% by weight percent of the finished gum, in a substantially liquid form. Glycerin and lecithin are then added to the gum making machine 102 downstream from the gum base, such as at inlet 124 at rates of about 4.9% by weight of the finished gum and about 3% by weight of the finished gum, respectively.

Dry sweeteners are added to the gum making machine 102 at inlet 116 downstream of the filler (added at inlet 121) and gum base (added at inlet 122). The dry sweeteners are injected into the gum making machine 102 by component injector 106 at inlet 116. Prior to being injected into the gum making machine 102, the dry sweeteners are metered onto conveyor 130 of metering conveyor apparatus 108 forming a stratified flow 118 of dry sweetener components.

A first dry sweetener metered on the conveyor apparatus is contemplated to include sorbitol, a large quantity component for this contemplated gum composition, at a weight percent of about 30% by weight of the finished gum from feeder A. As such, sorbitol forms the first layer of the stratified flow 118 formed by the components of metering conveyor apparatus 108 traveling along path 134. Downstream from the addition of sorbitol, lower quantity sweeteners in the form of high intensity sweeteners, more particularly sucralose, at the rate of about 1% by weight of the finished gum is added as the next ingredient component of the stratified flow 118. The sucralose may be fed, for example, from feeder B. As the sucralose is added downstream of the large quantity ingredient sorbitol, the sucralose resides on top of the sorbitol, such as is illustrated for example by ingredients A and B, respectively, in FIG. 3. Moving along path 134, encapsulated sweetener in the form of encapsulated sucralose is added to the stratified flow 118 from feeder C₁ at a rate of about 4% by weight of the finished gum. Again, the encapsulated sweetener resides on top of the sorbitol and sucralose. Finally, a second large quantity component, which is the same component as the first large quantity component sorbitol, is added to the stratified flow 118 at a rate of about 25% by weight of the finished gum from feeder Cₙ. As illustrated in FIG. 3, the large quantity sorbitol Cₙ covers the low quantity components sucralose B and encapsulated sucralose C₁, such that the low quantity components are encapsulated between the top layer of sorbitol Cₙ and the lower layer of sorbitol A. The stratified flow 118 is then dispensed onto transfer conveyor 104 where it is added to component injector 106, which injects the stratified flow 118 into the gum making machine 102.

Downstream from inlet port 116, additional liquid components including flavors, acids and color are injected into gum making machine 102 in a liquid form at a rate of about 1% by weight of the finished gum, 1% by weight of the finished gum, 0.1% by weight of the finished gum, respectively, are added to gum making machine 102 at inlet 126.

These examples illustrate several features of embodiments of the present invention. First, a large quantity component can be used to encapsulate or cover the lower quantity components. Second, a single large quantity component can be used in multiple layers to both protect the conveyor from contamination as well as to cover and encapsulate the low quantity components. Further, the ratio of the various components metered onto conveyor 130 will remain substantially constant.

While the previous examples illustrated the use of conveyor apparatus 108 in combination with the finished gum ingredients, i.e. sweeteners, the conveyor apparatus 108 may be used with other ingredients as well. For example, the conveyor apparatus 108 could be used in gum making machines that strictly form gum bases. Thus, all of the gum components added would be gum base ingredients.

Additionally, a conveyor apparatus 108 could be used to convey some finished gum components (Table 1) in combination with some gum base components (Table 2).

Further, embodiments and benefits of various embodiments of practicing the present invention will now be described.

It will be noted that in the embodiments illustrated and described above with regard to FIGS. 2, 3, 4 and 6, that only the component A, sorbitol, is in contact with the conveying surface 132, whereas in FIG. 5, all of the various components A-Cₙ are in contact with the conveying surface 132. Where the same metering conveyor apparatus 108 is to be used for supplying various formulations of dry gum components, the stratified flow 118 of gum components can be constructed to provide a considerable advantage in change-over from one gum formulation to another by arranging to always have the component in contact with the conveying surface 132 be common to the various gum formulations. For example, the component mannitol is a typical high-volume dry component utilized for making gum. By arranging the layers of the stratified flow 118 of two different gum formulations to always have a layer of mannitol as the only component in contact with the conveying surface 132, in two or more dry gum component formulations prepared and conveyed by the metering conveyor, the necessity for extensive cleaning of the conveying surface 132 as part of a change-over from a first to a second gum formulation is substantially eliminated.

For example, with reference to FIG. 3 or 4, a method taking advantage of this aspect of the invention may involve a first step of forming a first substantially horizontally stratified flow 118 of dry gum components A-Cₙ by depositing a flow of a first dry gum component A of the two or more dry gum components A-Cₙ onto the conveying surface 132 upstream from the delivery location D, and sequentially depositing a flow of each of the one or more additional dry gum components B-Cₙ on the first dry gum component A in such a manner that the one or more additional dry gum components B-Cₙ are substantially isolated from contact with the conveying surface 132 by the first dry gum component A.

After a production run of the first gum formulation is completed, any remaining portion of the stratified flow of dry gum components 118 is removed from the conveying surface 132. In the exemplary embodiment of the gum making apparatus 100 shown in FIG. 1, this may be accomplished by having the controller open a scrap gate 138 at the downstream end of the transfer conveyor 104, and running both the metering conveyor 108 and transfer conveyor 104, after the feeders A-Cₙ have been shut-off, to direct any remaining dry gum components on the conveying surface 132 of the metering conveyor 108 and in the transfer conveyor 104 into a scrap bin 140.

A second formulation of a substantially horizontally stratified flow of dry gum components 118 may then be established on the metering conveyor 108 having a different constant cross-sectional ratio of dry gum components, wherein for example, one or more of the secondary and tertiary components B-Cₙ is eliminated or changed to a different component, with the first dry gum component A remaining the same in the second formulation of dry components as it was in the first formulation of dry gum components 118.

Specifically, the first component A of the first formulation of horizontally stratified flow 118 is retained as the first component of the second flow 118 of horizontally stratified flow 118 of two or more dry gum components, such that the first component A substantially isolates the remaining components of the second formulation of flow of dry components 118 from the conveying surface 132 in the same manner as it did with the first formulation of substantially horizontally stratified flow of dry gum components 118. In this manner, no cleaning of the conveying surface, or just a simple brushing off of the conveying surface may be all that is required as a preparatory step during the change-over from the first formulation of a stratified flow of dry gum components to the second formulation of a stratified flow of gum components, in accordance with the invention.

The invention also provides an apparatus and methods having considerable advantage in dealing with changes in feed rates or starting and stopping of the feeding of dry gum components A-Cₙ, which are essentially inherent in the process of making gum.

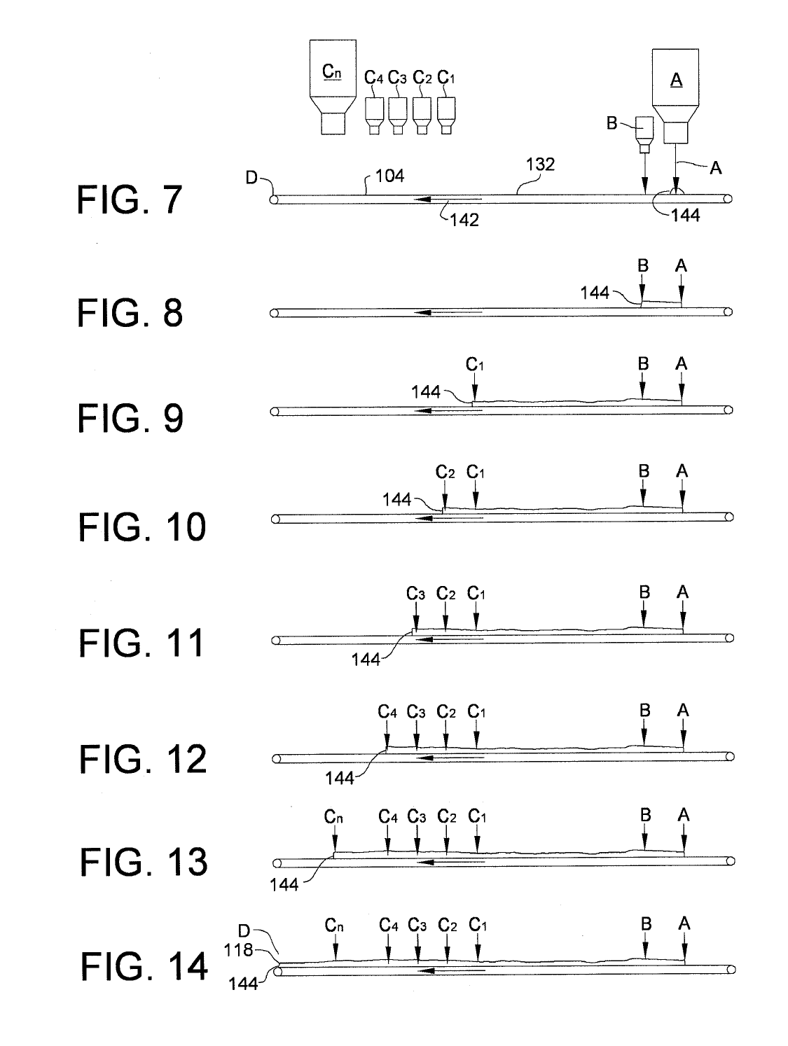

For example, FIGS. 7-13 illustrate a control scheme, in accordance with the invention, for forming a stratified flow 118 of dry gum components by sequentially initiating deposition of each of the dry gum components A-Cₙ. As shown in FIG. 7, with the conveying surface 132 moving in a direction toward the delivery location D (as indicated by arrow 142), deposition of the first dry component A is initiated at a location along the conveying path farthest from the delivery location D, to thereby form a leading edge 144 of the first dry component A. As shown in FIGS. 8-13, deposition of each additional dry gum component B-Cₙ is sequentially initiated as the leading edge 144 of the first dry component A reaches and moves past the respective feeder location B-Cₙ for that additional dry gum component B-Cₙ, such that the substantially horizontally stratified flow of the gum components A-Cₙ is fully formed in the desired cross-sectional ratio when the leading edge 144 of the first dry gum component A has substantially reached the location of the last feeder Cₙ. The conveying surface 132 then conveys the fully established stratified flow 118 from the location of the last component feeder Cₙ to the delivery location D along the conveying path 104.

By virtue of the above method and apparatus, the invention facilitates efficient and effective formulation of the stratified flow of dry gum components 118 at the start-up of a gum making process, in such a manner that no waste is produced, with a desired cross-sectional ratio of components being fully established by the time that the flow 118 of dry components initially reaches the delivery location D.

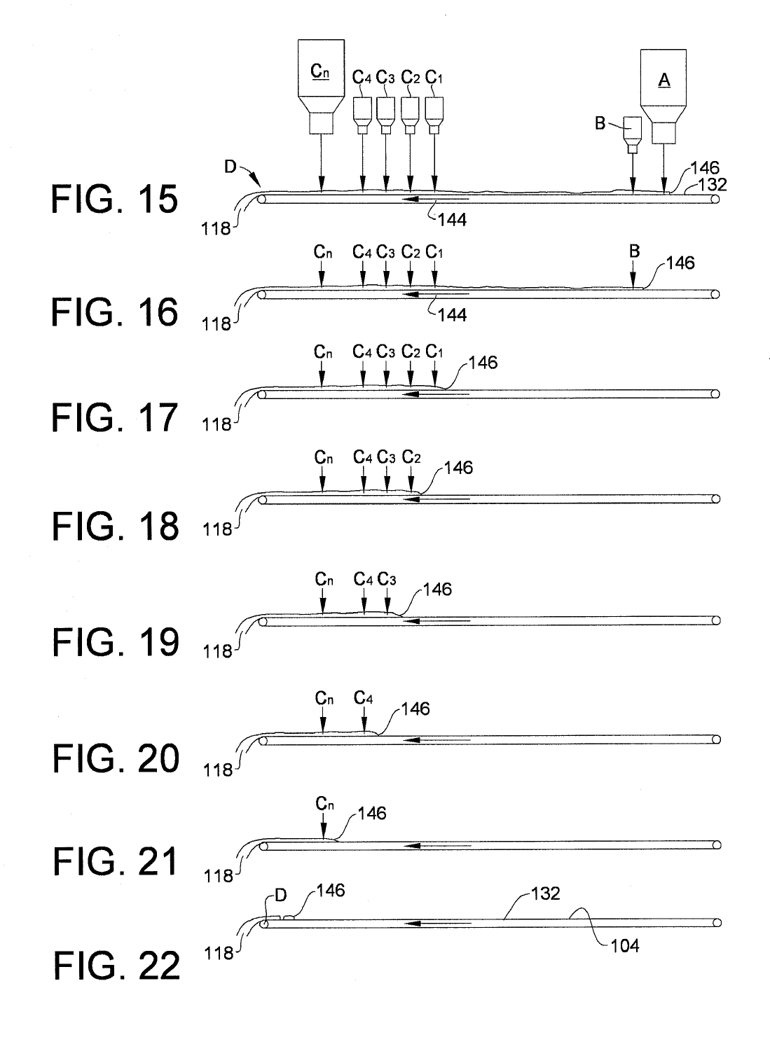

In similar fashion, the apparatuses and methods of the invention provide an efficient and effective approach to stopping the flow of the dry gum components 118, at the end of a production run for example, by sequentially stopping deposition of each of the dry gum components A-Cₙ. Specifically, as illustrated sequentially in FIGS. 15-22, where a fully developed stratified flow 118 of dry gum components has been established, as shown in FIG. 15A, deposition of each of the components A-Cₙ is terminated, starting with A as shown in FIG. 16 at the location along the conveying path 104 farthest from the delivery location D to form a trailing edge 146 of the first dry gum component A, and subsequently stopping deposition of each additional dry gum components B-Cₙ as the trailing edge 146 of the first dry gum component A has substantially reached the respective feeder location B-Cₙ for that additional dry gum components A-Cₙ. In this manner, the constant cross-sectional ratio within the substantially horizontally stratified flow 118 of dry gum components is maintained, until the trailing edge 146 of the dry gum component A has substantially reached the delivery location D along the conveying path 104, such that no improperly mixed dry components are delivered by the metering conveyor 108, and further such that the conveying surface 132 behind the trailing edge 146 is left substantially free of any dry gum components A-Cₙ.

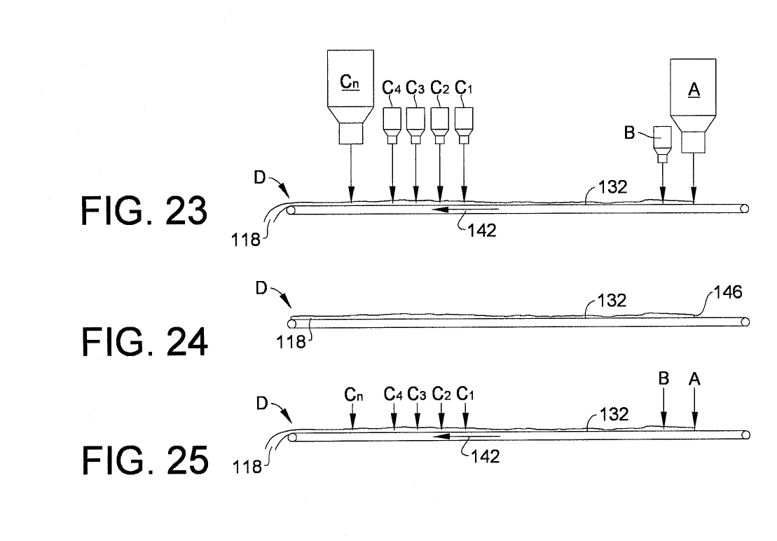

FIGS. 23-25 illustrate two other control schemes that may be utilized with an apparatus or method, according to the invention.

As shown in FIG. 23, once a substantially stratified flow of dry components 118 has been fully established, by a process such as the one described above in conjunction with FIGS. 7-14, for example, deposition of all of the components A-Cₙ may be stopped simultaneously with a stoppage of movement 142 of the conveying surface 132, to reach a paused condition, as illustrated in FIG. 24, where the process of forming the substantially stratified flow of dry components is suspended with the various components A-Cₙ at rest upon the conveying surface 132 from the trailing edge 146 of the first component A to the delivery location D. Such a control scheme may be used, for example, if it becomes necessary to interrupt the gum making process temporarily, with anticipation of re-starting the gum making process, or at the end of a production run where components other than those delivered by the metering conveyor 108 have run-out prior to the flow of dry components 118 being entirely consumed.

As shown in FIG. 25, after the flow of dry gum components 118 has been temporarily suspended, in the manner described above with regard to FIGS. 23 and 24, another control scheme for an apparatus or method according to the invention allows the stratified flow of dry gum components 118 to be instantaneously reestablished, without any loss of the desired proper ratio between the dry gum components A-Cₙ, by restarting deposition of each of the dry gum components A-Cₙ substantially simultaneously with restarting of the motion 142 of the conveying surface 132.

From the foregoing descriptions of preferred embodiments of apparatuses and methods according to the invention, those having skill in the art will recognize that the invention provides for effective and efficient delivery of a flow of dry components in a substantially constant cross-sectional ratio of the dry gum components. In addition to the aspects and exemplary embodiments of the invention discussed above, it will be recognized that, by controlling the rate of feed of the dry gum components A-Cₙ in relation to the speed of movement in the direction 142 of the conveying surface 132, the desired constant ratio can be maintained and provided to the gum making machine 102 at whatever rates are necessary to provide for a continuous output feed of gum 103 from the gum making machine 102.

The controllability of the conveyor 130 described previously permits the conveyor to be used to feed ingredients to multiple gum making machines, albeit not simultaneously, but by merely reversing the direction of flow of the conveyor 130 and more particularly the conveying surface 132. As such, the conveyor 130 could be used to feed two gum making machines that are arranged at opposite ends of the conveyor 130 by reversing the direction the conveying surface travels and the direction at which the horizontally stratified flow 118 is formed.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for making gum, comprising conveying a substantially horizontally stratified flow of two or more gum components along a conveying path in a substantially constant cross-sectional ratio of the gum components along the conveying path.

2. The method of claim 1, wherein all of the gum components are dry components.

3. The method of claim 2, wherein, the dry gum components include at least one high volume component and at least one low volume component, and the method further comprises, depositing and retaining at least one of the at least one low volume component between a first and a second substantially horizontally stratified layer of the at least one high volume component as the two or more dry gum components are transported along a conveying path to a delivery location along the conveying path.

4. The method of claim 3, wherein the high-volume component is a bulk sweetener, and the low volume component is a high-intensity sweetener.

5. The method of claim 2, wherein, the conveying path is at least partially defined by a conveying surface that is moving along the conveying path and terminates at a delivery location along the conveying path, and the method further comprises:
forming a first formulation of a substantially horizontally stratified flow of dry gum components by depositing a flow of a first dry gum component of the two or more dry gum components onto the conveying surface upstream from the delivery location, and sequentially depositing a flow of one or more additional dry gum components on the first dry gum component in such a manner that the one or more additional dry gum components are substantially isolated from contact with the conveying surface by the first dry gum component;
removing the first formulation of the substantially horizontally stratified flow of dry gum components from the conveying surface; and
forming a second formulation of a substantially horizontally stratified flow of dry gum components having a different substantially constant cross-sectional ratio of dry gum components, but retaining the first component of the first formulation of the substantially horizontally stratified flow of two or more dry gum components as the first dry gum component of the second formulation of the substantially horizontally stratified flow of two or more dry gum components, such that the first dry gum component substantially isolates the remaining components of the second formulation of dry components from the conveying surface in the same manner as with the first formulation of the substantially horizontally stratified flow of dry gum components.

6. The method of claim 1, further comprising:
feeding the substantially horizontally stratified flow of two or more components to a gum making machine; and
combining the horizontally stratified flow of the two or more components with flows of one or more additional gum components in the gum making machine to form a gum composition.

7. The method of claim 6, wherein the gum making machine is a substantially continuous flow extruder, and the method further comprises, controlling the substantially horizontally stratified flow of the two or more gum components and the flow of the one or more additional gum components to provide a substantially continuous flow of the gum composition from the gum making machine.

8. The method of claim 5, further comprising:
conveying the substantially horizontally stratified flow of the two or more gum components to a delivery location along at least a portion of the conveying path on a conveying surface moving along the conveying path with each of the two or more dry components being deposited into the substantially horizontally stratified flow of the two or more gum components at respective feeder locations spaced from one another along the portion of the conveying path; and
controlling the deposition of each the two or more dry components according to one or more of control schemes a, b, c, or d below:
a) sequentially initiating deposition of each of the two or more dry gum components starting with initiation of deposition of a first dry component of the two or more dry gum components at a location along the portion of the conveying path farthest from the delivery location to form a leading edge of the first dry component and sequentially initiating deposition of each additional dry gum component of the two or more dry gum component as the leading edge of the first dry component has substantially passed the respective feeder location for that additional dry gum component, to thereby establish the substantially horizontally stratified flow of two or more dry gum components when the leading edge of the first dry gum component has substantially reached the delivery location along the conveying path;
b) sequentially stopping deposition of each of the two or more dry gum components starting with termination of deposition of a first dry component of the two or more dry gum components at a location along the portion of the conveying path farthest from the delivery location to form a trailing edge of the first dry component and subsequently stopping deposition of each additional dry gum component of the two or more dry gum component as the trailing edge of the first dry component has substantially reached the respective feeder location for that additional dry gum component, to thereby maintain the substantially horizontally stratified flow of two or more dry gum components to the delivery location until the trailing edge of the first dry gum component has substantially reached the delivery location along the conveying path, and leaving the conveying surface behind the trailing edge substantially free of any of the two or more dry gum components;
c) simultaneously stopping movement of the conveying surface along the conveying path and deposition of each of the two or more dry gum components;
d) simultaneously starting movement of the conveying surface along the conveying path and deposition of each of the two or more dry gum components.

9. The method of claim 1, wherein the gum components include at least one high volume gum component and at least one low volume gum component, and the method further comprises, depositing at least one of the at least one low volume gum component onto a first layer of an at least one high volume gum component.

10. The method of claim 9, wherein the low volume gum component is a non-dry gum component and at least one high volume component is a dry gum component.

11. The method of claim 10, further comprising retaining the at least one low volume gum component deposited onto the first layer of the at least one high volume component between the first layer and a second substantially horizontally stratified layer of the at least one high volume gum component as the two or more gum components are transported along a conveying path to a delivery location along the conveying path.

12. The method of claim 1, wherein, the conveying path is at least partially defined by a conveying surface that is moving along the conveying path and terminates at a delivery location (D) along the conveying path, and the method further comprises, depositing a flow of a first gum component (component A) of the two or more gum components onto the conveying surface upstream from the delivery location D, and sequentially depositing a flow of a second component (component B) of the two or more gum components on top of component A in such a manner that the flow of component B rests on the flow of component A and is substantially isolated from contact with the conveying surface by component A.

13. The method of claim 12, wherein, the flow of gum components further comprises a third component (component C), and the method further comprises, depositing the flow of component C subsequent to depositing component B in such a manner that component C is substantially isolated from contact with the conveying surface by at least component A.

14. The method of claim 13, wherein, the method further comprises, depositing the flow of component C onto the flow of component B in such a manner that component C is substantially isolated from contact with the conveying surface by both component B and component A.

15. The method of claim 14, wherein component A and component C constitute a first and a second high volume component and component B constitutes a low volume component, the method comprising, depositing and retaining the low volume component B between the first and second high volume components A and C as components A, B and C are transported along the conveying path to the delivery location.

16. The method of claim 12, wherein, the flow of gum components contains flows of first and second components A, B and one or more tertiary components (component C₁ . . . Cₙ) sequentially deposited on top of one another to form a substantially stratified flow of materials with substantially only component A being in contact with the conveying surface.

17. The method of claim 16, further comprising, changing the components in the flow of gum components to form an alternate formulation of the flow of gum components, but retaining component A in contact with the conveying surface and substantially isolating the remaining components of the flow of components from the conveying surface.

18. The method of claim 17, further comprising, sequentially depositing the flows of components in such a manner that the stratified components are deposited in a substantially constant longitudinal order along the conveying path from a location of initial deposit of component A to the delivery location D; and
further comprising, controlling the manner that the stratified components are deposited in a substantially constant longitudinal order along the conveying path from a location of initial deposit of component A to the delivery location, during at least one of initiation or termination of movement of the conveying surface along the conveying path.

19. A method for conveying a flow of two or more gum components in a desired ratio of the components to a delivery location along a conveying path, where the gum components contain a first high volume component and a second low volume component, the method comprising, depositing and retaining the low volume component between a first and a second substantially horizontally stratified layer of the high volume component as the two or more components are transported along the conveying path to the delivery location.

20. The method of claim 19, further comprising:
first, depositing a first quantity of the high volume component onto a conveying surface moving along the conveying path toward the delivery location;
second, depositing a quantity of the low volume component onto the quantity of high volume component on the conveying surface; and
then, depositing a second quantity of the high volume component over the quantity of low volume component, to thereby substantially enclose the deposited quantity of low volume component between the first and second quantities of the high volume component.

21. The method of claim 20, wherein, the conveying surface is movable along the conveying path from a first feeding location to a second feeding location along the conveying path, and the method further comprises:
depositing the first and second quantities of the high volume component at the first and second feeding locations respectively; and
depositing the low volume component at an intermediate feeding location along the conveying path disposed between the first and second feeding locations.

22. The method of claim 21, further comprising, driving the conveying surface while depositing the components in such a manner that the components form a continuous band of the components on the conveying surface having a substantially constant cross-sectional ratio of the continuous band substantially matching the desired ratio of the high and low volume components along the conveying path; and
further comprising, sequentially initiating deposition of the first quantity of the high volume component first, the low volume component second, and the second quantity of the high volume component last, when initiating motion of the conveying surface, such that the components are deposited in the substantially constant cross-sectional ratio from the second location along the conveying path and beyond, and such that the low volume component is not deposited onto the conveying surface before the first quantity of high volume component has substantially passed the intermediate location; and
further comprising, sequentially terminating deposition of the first quantity of the high volume component first, the low volume component second, and the second quantity of the high volume component last, when terminating motion of the conveying surface, such that the components are deposited in the substantially constant cross-sectional ratio from the second location along the conveying path and beyond, and such that the low volume component is not deposited onto the belt after the first quantity of high volume component has substantially passed the intermediate location.

23. An apparatus for conveying a substantially stratified flow of two or more gum components in a desired ratio of the components to a delivery location along a conveying path, where the gum components contain at least a first dry gum component (component A) and a second gum component (component B), the apparatus comprising:
a conveying arrangement having a conveying surface that is movable along the conveying path from a location of depositing component A to the delivery location; and
a component feeder arrangement for depositing a flow of the first dry gum component (component A) of the two or more components onto the conveying surface at the location of depositing component A, and sequentially depositing a flow of component B on top of component A in such a manner that the flow of component B rests on the flow of component A and is substantially isolated from contact with the conveying surface by component A.

24. The apparatus of claim 23, wherein, the flow of gum components includes one or more tertiary components (component C₁ . . . Cₙ), and the component feeder apparatus further comprises:
a first component feeder (feeder A) disposed along the conveying path for depositing the flow of component A at location A;
a second component feeder (feeder B) disposed along the conveying path for depositing the flow of component B at a location B spaced along the conveying path between location A and the delivery location; and
one or more tertiary component feeders (feeder C₁ . . . Cₙ) disposed along the conveying path at a respective tertiary location (tertiary location C₁ . . . Cₙ) between location B and the delivery location D for depositing a flow for each one of the one or more tertiary components C₁ . . . Cₙ at its respective tertiary location C₁ . . . Cₙ.

25. The apparatus of claim 24, further comprising, a controller operatively attached to the conveying arrangement and feeding arrangement for controlling the conveying and feeding arrangements to sequentially deposit one or more of the first, second and tertiary components A, B, C₁ . . . Cₙ on top of one another to form a substantially stratified flow of components with substantially only component A being in contact with the conveying surface; and
wherein:
the flow of component A defines a leading edge thereof during establishment of the flow of components from feeder location A toward the delivery location D; and
the controller sequentially initiates deposition of the second and tertiary components B and C₁ . . . Cₙ as the leading edge of component A has substantially passes each respective feeder location B and C₁ . . . Cₙ; and
wherein:
the flow of component A defines a trailing edge thereof during termination of the flow of components from feeder location A toward the delivery location D; and
the controller sequentially terminates deposition of the second and tertiary components B and C₁ . . . Cₙ after the trailing edge of component A has substantially reaches each respective feeder location B and C₁ . . . Cₙ.

26. The apparatus of claim 24, further comprising, a controller operatively attached to the conveying arrangement and feeding arrangement for controlling the conveying and feeding arrangements to sequentially deposit one or more of the first, second and tertiary components A, B, C₁ . . . Cₙ on top of one another to form a substantially stratified flow of components with substantially only component A being in contact with the conveying surface; and
wherein, the controller controls the deposition of the first, second and tertiary components (A, B, C₁ . . . Cₙ) according to one or more of control schemes a, b, c, or d below:
a) sequentially initiating deposition of each of the first, second and tertiary components (A, B, C₁ . . . Cₙ) starting with initiating deposition of component A by feeder A the first feeding location A to form a leading edge of the first dry component A and subsequently sequentially initiating deposition of the second component B and each tertiary component C₁ . . . Cₙ as the leading edge of the first dry component A has substantially passed the respective feeder location B, C₁ . . . Cₙ for that dry gum component, to thereby establish the substantially horizontally stratified flow of the first, second and tertiary gum components (A, B, C₁ . . . Cₙ) when the leading edge of the first gum component A has substantially reached the delivery location along the conveying path;
b) sequentially terminating deposition of each of the first, second and tertiary components (A, B, C₁ . . . Cₙ) starting with terminating deposition of component A by feeder A the first feeding location A to form a trailing edge of the first component A and subsequently sequentially terminating deposition of the second component B and each tertiary component C₁ . . . Cₙ as the trailing edge of the first component A has substantially reached the respective feeder location B, C₁ . . . Cₙ for that dry gum component, to thereby maintain the substantially horizontally stratified flow of the first, second and tertiary gum components (A, B, C₁ . . . Cₙ) until the trailing edge of the first gum component A has substantially reached the delivery location along the conveying path;
c) simultaneously stopping movement of the conveying surface along the conveying path and deposition of each of the first, second and tertiary gum components (A, B, C₁ . . . Cₙ);
d) simultaneously starting movement of the conveying surface along the conveying path and deposition of each of the first, second and tertiary gum components (A, B, C₁ . . . C_{d}).
